(19) United States
(12) Patent Application Publication
(10) Pub. No.: US 2026/0281201 A1
(43) Pub. Date: Sep. 17, 2026

(54) METHOD, DEVICE AND STORAGE MEDIUM FOR MESSAGE COMMUNICATION

(71) Applicants: Beijing Zitiao Network Technology Co., Ltd., Beijing (CN); Bytedance Technology Ltd., Grand Cayman (KY)

(72) Inventors: Mengjun ZHANG, Beijing (CN); Fanglin SUN, Beijing (CN); Zhuochen GE, Los Angeles, CA (US); Zhimin HAN, Beijing (CN); Xiaochan WANG, Beijing (CN); Yu DONG, Beijing (CN); Ruiqi ZHU, Beijing (CN); Rui ZHANG, Beijing (CN); Shiqian ZHANG, Beijing (CN); Haoyuan LI, Beijing (CN); Ximou CHENG, Beijing (CN); Shibo WEN, Beijing (CN); Hao ZHANG, Beijing (CN); Chuanhao ZHAN, Beijing (CN); Qigeng CHEN, Beijing (CN)

(21) Appl. No.: 19/370,055

(22) Filed: Oct. 27, 2025

(30) Foreign Application Priority Data
Mar. 13, 2025 (CN) 202510301183.9

(51) Int. Cl. H04L 67/55; H04L 67/145

(52) U.S. Cl. CPC H04L 67/55; H04L 67/145

(57) ABSTRACT

According to embodiments of the disclosure, a method, device, and storage medium for message communication are provided. The method includes: receiving, from a server device via a communication link between a client device and the server device, duration information indicating a duration for which an application in the client device is required to remain in an active state; transmitting, in response to receiving a notification message, the notification message to the server device via the communication link; controlling, in response to the transmitting of the notification message, the application to remain in the active state at least for the indicated duration, where the communication link is maintained while the application is in the active state; and receiving, from the server device via the communication link, a summary message determined based on at least one notification message sent from the client device.

### CROSS-REFERENCE

The present application claims priority to Chinse Patent Application No. 202510301183.9, filed on Mar. 13, 2025, entitled “Method, Apparatus, Device, and Storage Medium for Message Communication”, the disclosures of which are incorporated herein by reference in their entireties.

### FIELD

Example embodiments of the present disclosure generally relate to the field of computers, and in particular, to a method, apparatus, device, and computer-readable storage medium for message communication.

### BACKGROUND

With the rapid development of the Internet, more and more applications are designed to provide various services to users. For example, an application deployed in a client device associated with a user may provide the user with a service of summarizing notification messages in the client device. The client device may output a summary message, which may facilitate the user to understand the notification messages received by the client device in a timely and convenient manner.

### SUMMARY

In a first aspect of the present disclosure, a method for message communication is provided. The method includes: receiving, from a server device via a communication link between a client device and the server device, duration information indicating a duration for which an application in the client device is required to remain in an active state; transmitting, in response to receiving a notification message, the notification message to the server device via the communication link; controlling, in response to the transmitting of the notification message, the application to remain in the active state at least for the indicated duration, where the communication link is maintained while the application is in the active state; and receiving, from the server device via the communication link, a summary message determined based on at least one notification message transmitted from the client device.

In a second aspect of the present disclosure, an apparatus for message communication is provided. The apparatus includes: an information receiving module configured to receive, from a server device via a communication link between a client device and the server device, duration information indicating a duration for which an application in the client device is required to remain in an active state; a message transmitting module configured to transmit, in response to receiving a notification message, the notification message to the server device via the communication link; a state control module configured to control, in response to the transmitting of the notification message, the application to remain in the active state at least for the indicated duration, where the communication link is maintained while the application is in the active state; and a message summary module configured to receive, from the server device via the communication link, a summary message determined based on at least one notification message transmitted from the client device.

In a third aspect of the present disclosure, an electronic device is provided. The device includes at least one processor; and at least one memory coupled to the at least one processor and storing instructions executable by the at least one processor, the instructions, when executed by the at least one processor, causing the device to perform the method of the first aspect.

In a fourth aspect of the present disclosure, a computer-readable storage medium is provided. The computer-readable storage medium has a computer program stored thereon, the computer program being executable by a processor to perform the method of the first aspect.

In a fifth aspect of the present disclosure, a computer program product is provided. The computer program product is tangibly stored in a computer storage medium and includes computer-executable instructions, the computer-executable instructions, when executed by a device, causing the device to perform the method of the first aspect.

It should be understood that the content described in this Summary section is not intended to identify key or essential features of the embodiments of the present disclosure, nor is it intended to limit the scope of the present disclosure. Other features of the present disclosure will become readily understood through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference numbers refer to the same or similar elements, where:

FIG. 1 illustrates a schematic diagram of an example environment in which embodiments according to the present disclosure may be implemented;

FIG. 2 illustrates a flowchart of a signaling flow of message communication according to some embodiments of the present disclosure;

FIG. 3 illustrates a schematic diagram of an example lifecycle of an application according to some embodiments of the present disclosure;

FIG. 4 illustrates a schematic diagram of an example summarization policy for notification messages according to some embodiments of the present disclosure;

FIG. 5 illustrates a flowchart of a signaling flow of message communication for a client device with a first type of system according to some embodiments of the present disclosure;

FIG. 6 illustrates a schematic diagram of an example process of message communication according to some embodiments of the present disclosure;

FIG. 7 illustrates a flowchart of a signaling flow of message communication for a client device with a second type of system according to some embodiments of the present disclosure;

FIG. 8 illustrates a flowchart of an example process of message communication according to some embodiments of the present disclosure;

FIG. 9 illustrates a schematic structural block diagram of an example apparatus for message communication according to some embodiments of the present disclosure; and

FIG. 10 illustrates a block diagram of an electronic device capable of implementing multiple embodiments of the present disclosure.

### DETAILED DESCRIPTION

Embodiments of the present disclosure will be described in more detail below with reference to the drawings. Although certain embodiments of the present disclosure are shown in the drawings, it should be understood that the present disclosure may be implemented in various forms and should not be interpreted as limited to the embodiments set forth herein. Instead, these embodiments are provided for a more thorough and complete understanding of the present disclosure. It is to be understood that the drawings and embodiments of the present disclosure are only used for purposes of examples, and are not used to limit the protection scope of the present disclosure.

It should be noted that the titles of any section/subsection provided herein are not restrictive. Various embodiments are described throughout this article, and any type of embodiment may be included under any section/subsection. In addition, the embodiments described in any section/subsection may be combined with any other embodiments described in the same section/subsection and/or different sections/subsections in any way.

In the description of the embodiments of the present disclosure, the term “include/comprise” and its similar terms should be understood as open-ended inclusions, that is, “include/comprise but not limited to”. The term “based on” should be understood as “based at least partially on”. The term “an embodiment” or “the embodiment” should be understood as “at least one embodiment”. The term “some embodiments” should be understood as “at least some embodiments”. Other explicit and implicit definitions may be included below. The terms “first”, “second”, etc. may refer to different or same objects. Other explicit and implicit definitions may be included below.

The embodiments of the present disclosure may involve user data, data acquisition and/or use, etc. These aspects all follow the corresponding laws, regulations and related provisions. In the embodiments of the present disclosure, the collection, acquisition, processing, machining, forwarding, use, etc. of all data are carried out on the premise that the user knows and confirms. Accordingly, when implementing the embodiments of the present disclosure, the user should be informed of the type, range of use, use scenario, etc. of the data or information that may be involved and the authorization of the user should be obtained through an appropriate manner according to relevant laws and regulations. The specific manner of informing and/or authorizing may change according to the actual situation and application scenario, and the scope of the present disclosure is not limited in this regard.

If the schemes in the specification and the embodiments involve personal information processing, the processing will be carried out on the premise that there is a legal basis (for example, the consent of the personal information subject is obtained, or it is necessary to perform a contract, etc.), and the processing will only be carried out within the specified or agreed scope. If the user refuses to process personal information other than the necessary information required for the basic function, it will not affect the use of the user of the basic function.

As used herein, the term “model” may learn corresponding relationship between input and output from training data, so that after the training is completed, the corresponding output may be generated for the given input. The generation of the model may be based on machine learning techniques. Deep learning is a machine learning algorithm that uses multiple processing units to process input and provide corresponding output. A neural network model is an example of a model based on deep learning. Herein, the “model” may also be referred to as a “machine learning model”, a “learning model”, a “machine learning network” or a “learning network”, and these terms are used interchangeably herein.

Generally, machine learning may roughly include three stages, namely, a training stage, a testing stage, and an application stage (also referred to as an inference stage). In the training stage, a given model may be trained using a large amount of training data, and parameter values may be updated through continuous iteration until the model may obtain consistent inference that meets an expected objective from the training data. Through training, the model may be considered to be able to learn, from the training data, an association from input to output (also referred to as a mapping from input to output). The parameter values of the trained model are determined. In the testing stage, a test input is applied to the trained model to test whether the model may provide a correct output, thereby determining the performance of the model. The testing stage may sometimes be incorporated into the training stage. In the application or inference stage, the trained model may be used to process an actual model input based on the parameter values obtained through the training and determine a corresponding model output.

As mentioned above, the application deployed in the client device may provide the user with the service of summarizing the notification messages in the client device. It may be understood that the state of the application in the client device changes dynamically. The system of the client device may control the application to dynamically switch between an active state and an inactive state. Currently, when the server device transmits, to the client device, the summary message for the notification message of the client device, the application may be in the inactive state. However, in the inactive state, the application cannot receive the summary message from the server. As a result, the user cannot obtain the summary message for the notification messages of the client device in a timely manner, reducing the user experience.

The embodiments of the present disclosure provide a solution for message communication. In this solution, duration information is received from a server device via a communication link between a client device and the server device, the duration information indicating a duration for which an application in the client device is required to remain in an active state. In response to receiving a notification message, the notification message is transmitted to the server device via the communication link. In response to the transmitting of the notification message, the application is controlled to remain in the active state at least for the indicated duration, where the communication link is maintained while the application is in the active state. A summary message is received from the server device via the communication link, the summary message being determined based on at least one notification message sent from the client device.

In this way, the embodiments of the present disclosure may ensure that the duration for which the application in the client device remains in the active state reaches at least the duration indicated by the duration information transmitted by the server device. In other words, the embodiments of the present disclosure may ensure that when the server device transmits the summary message to the client device, the application in the client device is in the active state. In this way, the application in the client device may receive the summary message from the server device in a timely manner, so that the user may obtain the summary message for the notification message in the client device in a timely manner, improving the user experience.

Various example implementations of this solution are described in detail below with reference to the drawings.

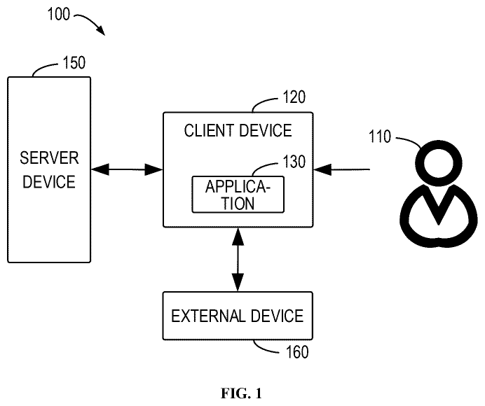

FIG. 1 illustrates a schematic diagram of an example environment 100 in which the embodiments of the present disclosure may be implemented. As shown in FIG. 1, the example environment 100 may include a user 110, a client device 120 associated with the user 110, a server device 150, and an external device 160 connected to the client device 120.

In the environment 100, the client device 120 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including accessories and peripherals of these devices or any combination thereof. In some embodiments, the client device 120 may also support any type of interface for the user 110 (such as a “wearable” circuit, etc.).

In the environment 100, the client device 120 may be deployed with an application 130 that provides a service. The application 130 may be any appropriate type of application for summarizing notification messages in the client device 120. The notification messages in the client device 120 may include a notification message for a system of the client device 120 (for example, a notification message for system power, a notification message for a network connection state of the system, etc.) and notification messages for various types of applications in the client device 120 (for example, a notification message for an information application, a notification message for a social communication application, etc.).

In some embodiments, the service provided by the application 130 may be implemented by the server device 150 communicatively linked to the application 130 using various methods. Different methods may use different summarization policies for the notification messages. Different summarization policies may take different durations. In some embodiments, the server device 150 may use a trained machine learning model (also referred to as a model for short) with certain capabilities (for example, natural language processing, clustering, information extraction, and other capabilities) to implement the service provided by the application 130. If the client device 120 receives a plurality of notification messages from a social communication application, such as “Let's have a party at XX restaurant at 12:00 am on Saturday”, “Remember to bring your camera”, and “20 people will participate in the party”, the application 130 in the client device 120 that may provide the message summarization service may transmit the plurality of notification messages to the server device 150 communicatively linked to the application 130. The server device 150 may use the machine learning model to generate, based on the plurality of notification messages, a summary message “[Contact name] invites you to have a party at XX restaurant at 12:00 am on Saturday. 20 people in total. Remember to bring your camera”. It should be noted that when the server device 150 uses the machine learning model to summarize messages, the server device 150 may be configured with different summarization policies. As the server device 150 may need to summarize a plurality of notification messages, and the server device 150 may use different summarization policies to summarize different notification messages, it may lead to different time intervals (or referred to as durations) from when the server device 150 receives the notification messages to when the server device 150 generates the summary message.

It is to be understood that the above only shows example models, applications, notification messages, and summary messages to which the present disclosure is applicable, and the embodiments of the present disclosure are not limited thereto.

In the environment 100, the client device 120 may communicate with the server device 150 to implement provision of the service of the application 130.

The server device 150 may be an independent physical server, a server cluster or a distributed system composed of a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network, and a big data and artificial intelligence platform. The server 150 may include, for example, a computing system/server, such as a mainframe, an edge computing node, a computing device in a cloud environment, and so on. The server device 150 may provide a backend service for the application 130 in the client device 120.

A communication link may be established between the server device 150 and the client device 120. The communication link may be established by a wired or wireless connection. The communication link may include but not limited to a Bluetooth connection, a mobile network connection, a universal serial bus (USB) connection, a wireless fidelity (WiFi) connection, etc., and the embodiments of the present disclosure are not limited in this regard.

In the environment 100, the external device 160 may be a terminal device that may be connected to the client device 120 through wireless communication or wired communication. The wireless communication method may include but not limited to cellular network communication, wireless local area network, Bluetooth, satellite communication, wireless personal area network, etc. The wired communication method may include but not limited to: USB communication, high definition multimedia interface (HDMI) communication, video graphics array (VGA) communication, etc. The external device 160 may include but not limited to: a wearable terminal device, a personal digital assistant (PDA), a portable computer, a desktop computer, an image capture terminal device such as a digital camera, a game terminal device, a music storage and playback device, a vehicle-mounted wireless terminal device, a wireless endpoint, a mobile station, a laptop embedded device (LEE), a laptop mounted device (LME), a universal serial bus (USB) dongle, a smart device, a wireless customer premise equipment (CPE), an Internet of Things (IoT) device, a watch or other wearable devices, a head-mounted display (HMD), a vehicle, a drone, a medical device and application (for example, remote surgery), an industrial device and application (for example, a robot and/or other wireless devices operating in an industrial and/or automated processing chain environment), a consumer electronic device, a device running on a commercial and/or industrial wireless network, etc.

In some embodiments, the external device 160 may output the summary message transmitted by the client device 120 to present to the user 110 associated with the client device 120. For example, the external device 160 may be a wireless headphone or speaker connected to the client device 120 through a wireless communication protocol (such as a Bluetooth protocol), a wired headphone, or a device connected through other communication links. After receiving the summary message transmitted by the server device 150, the client device 120 may transmit the summary message to the headphone to broadcast the summary message through the headphone. The user 110 may receive the summary message timely through the headphone.

It is to be understood that the structure and function of each element in the environment 100 are described only for purposes of example, and do not imply any limitation on the scope of the present disclosure.

Some example embodiments of the present disclosure will be described below with continued reference to the drawings.

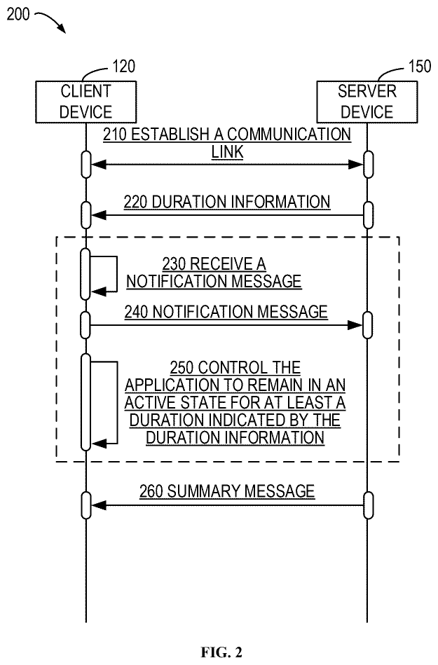

FIG. 2 illustrates a flowchart of a signaling flow of message communication according to some embodiments of the present disclosure. A process 200 may be implemented based on the environment 100 shown in FIG. 1. The message communication shown in FIG. 2 will be described below in combination with FIG. 1.

As shown in FIG. 2, when the application 130 in the client device 120 starts, the client device 120 may establish (210) a communication link with the server device 150. The communication link may be, for example, a long link based on the WebSocket protocol, or a communication link based on any appropriate communication protocol. The client device 120 may communicate with the server device 150 through the established communication link. In some embodiments, messages communicated through the established communication link may include but not limited to: operating system notification messages in the client device 120, application notification messages, and summary messages of the server device 150 for the notification messages in the client device, etc.

In the embodiments of the present disclosure, via the communication link established (210) between the client device 120 and the server device 150, the server device 150 may transmit, to the client device 120, duration information indicating a duration for which the application in the client device 120 is required to remain in an active state. In some embodiments, the operating system of the client device 120 may manage an entire process (or referred to as a lifecycle of the application) of the application (e.g., the application 130 shown in FIG. 1) in the client device 120 from start to termination. The lifecycle of the application usually includes various states of the application. Different states may reflect different stages of the running of the application on the client device 120.

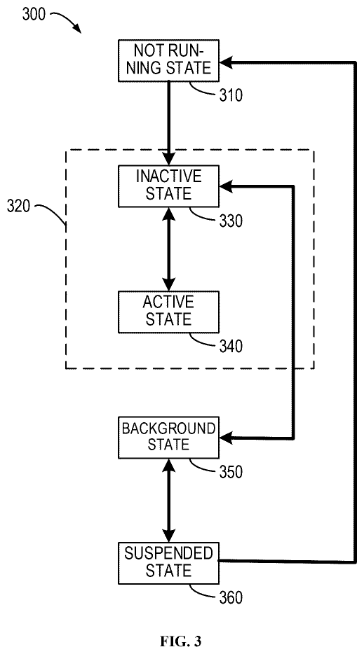

FIG. 3 illustrates a schematic diagram of an example lifecycle 300 of an application according to some embodiments of the present disclosure. As shown in FIG. 3, in some embodiments, the various states of the application may include a not running state 310, an inactive state 330, an active state 340, a background state 350, and a suspended state 360. The not running state 310 is usually the initial state of the application or the state of the application after being completely closed by the user 110. In the not running state 310, the application is usually not loaded in the memory and does not execute code. The inactive state 330 and the active state 340 belong to a foreground state 320 of the application. The inactive state 330 indicates a state in which the application is in the foreground but temporarily cannot receive input from the user 110. The inactive state 330 usually appears in a transition stage in which the application is about to enter the background or return to the foreground from the background. For example, when the operating system of the client device 120 pops up a phone call interface, a text message prompt box, etc. to cover the application, the application usually enters the inactive state 330.

Continuing to refer to FIG. 3, the active state 340 indicates a state in which the application is in the foreground and may receive input from the user 110 (or in other words, referred to as may interact with the user 110). For example, in scenarios in which the user 110 is using a social communication application to view messages, post messages to Moments, or perform game operations in a game application, the application is in the active state 340. After the application is switched to run in the background or the client device is in a screen lock state, the application may be switched to the background state 350. In the background state 350, the application is still in the active state. At this time, the application is running in the background and is still in the memory, but the application may not directly interact with the user 110. For example, when the user uses a music application to play music and the music application is switched to run in the background, the music application is in the background state 350 at this time, and the music may still be played. The suspended state 360 indicates a state in which the application is in the background and is paused by the operating system of the client device 120, so that the application does not occupy CPU resources, and is only retained in the memory. For example, after the application is switched to run in the background or the client device is locked for a period of time, if there is no task that needs to be continuously executed, the application may automatically enter the suspended state 360.

It may be understood that after the application is switched to run in the background, the application in the background state 350 may continuously run code logic, which may cause relatively high power consumption. The application in the suspended state 360 may be considered to be in the sleep state. At this time, the code logic of the application cannot be executed. In the suspended state 360 of the application, the communication link between the client device 120 and the server device 150 may be in the sleep state or disconnected, resulting in that the client device 120 and the server device 150 cannot communicate in a timely manner. However, it may be understood that controlling the application to enter the suspended state 360 may ensure a reduction in the memory usage of the operating system of the client device 120, and may also ensure that the application is quickly woken up when the application needs to execute a task.

It should be understood that the operating system of the client device 120 may control the application to perform state switching. For the switching between the various states of the application, reference may be made to the arrows shown in FIG. 3.

Based on the above description, to ensure that the client device 120 receives the summary message sent by the server device 150 timely, it is necessary to ensure that the application 130 remains in the active state for at least a certain duration to receive the summary message. The active state may include the application running in the foreground, or the application running in the background but still being in an activatable background state. In other words, the active state may indicate that the application is in a state other than the suspended state. As long as the application is continuously in a non-suspended state, the communication link corresponding to the application will not be disconnected or set to the sleep state, so that the summary message may be received from the server device 150 timely via the communication link. As will be discussed below, the duration for which the application 130 is required to remain in the active state is associated with the duration required for the server device 150 to summarize the notification messages in the client device 120. Therefore, in some embodiments, the server device 150 may determine, based on some summarization policies, a duration required for summarizing all received notification messages after receiving all the notification messages to be summarized, and determine, based on the duration, a duration for which the application 130 at the client device 120 is required to remain in the active state. The duration indicates the shortest duration for which the application 130 is required to remain in the active state after the client device 120 transmits the last notification message to be summarized and before the client device 120 receives the summary message from the server device 150.

In some embodiments, the duration required for the server device 150 to summarize the received notification message may be related to the applied summarization policy. The applied summarization policy may include one or more machine learning model-based summarization policies, and/or one or more rule-based policies. For different summarization policies, the server device 150 or the machine learning model may summarize different numbers of notification messages and/or use different processing methods to summarize the notification messages. In this case, the durations required for summarizing the notification messages based on different summarization policies may be different.

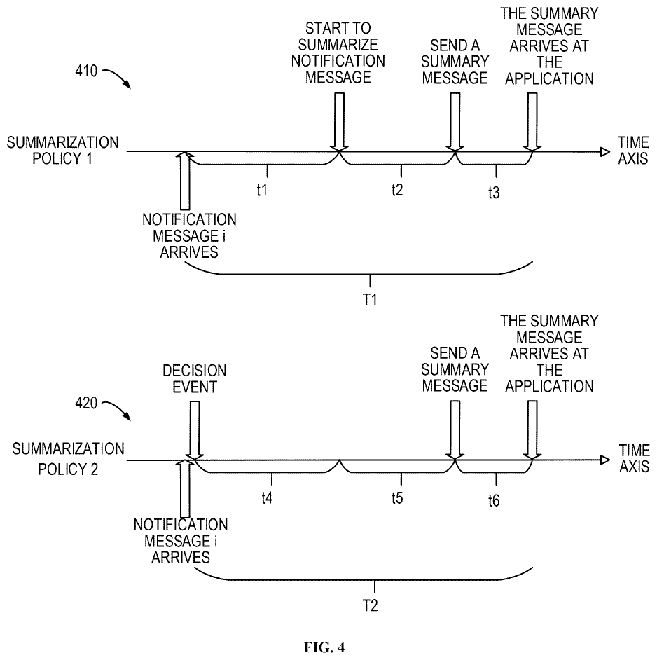

FIG. 4 illustrates a schematic diagram of example summarization policies for notification messages according to some embodiments of the present disclosure. In some embodiments, the model of the server device 150 may use one of summarization policy 1 410 or summarization policy 2 420 shown in FIG. 4 to summarize the notification message from the client device 120. For the purpose of illustration, the summarization duration corresponding to the summarization policy 1 410 is denoted as T1, and the summarization duration corresponding to the summarization policy 2 420 is denoted as T2.

As an example, a plurality of time points involved in the summarization policy 1 410 shown in FIG. 4 may include time points when: a certain notification message (denoted as notification message i) of the client device 120 arrives at the server device 150, the server device 150 starts to summarize notification messages (including at least the notification message i), the server device 150 sends a summary message for the notification messages, and the summary message arrives at the application 130 of the client device 120. For the purpose of illustration, the time interval between the notification message i arriving at the server device 150 and the server device 150 starting to summarize the notification messages is denoted as t1, the time interval between the server device 150 starting to summarize the notification messages and the server device 150 sending the summary message is denoted as t2, and the time interval between the server device 150 sending the summary message and the summary message arriving at the application 130 of the client device 120 is denoted as t3. It may be understood that the summarization duration T1=t1+t2+t3.

As another example, a plurality of time points involved in the summarization policy 2 420 shown in FIG. 4 may include time points when: a certain notification message (denoted as notification message i) of the client device 120 arrives at the server device 150, the model of the server device 150 starts to perform a decision event for the notification message i, the model of the server device 150 starts to summarize notification messages (including at least the notification message i), the server device 150 sends a summary message for the notification messages, and the summary message arrives at the application 130 of the client device 120.

It should be noted that the decision event for the notification message i may indicate an event in which the model of the server device 150 decides on the timeliness of the response of the model to the notification message i based on an urgency of the notification message i. If the notification message i has a high urgency, the model may respond to the notification message i with high timeliness. Correspondingly, if the notification message i has a low urgency, the model may respond to the notification message i with low timeliness.

It may be understood that the urgency of the notification message i may indicate the influence of the notification message i on the operating system of the client device 120 and/or the user 110. The notification message with the high urgency may include but not limited to: a notification message indicating a security risk of the operating system (e.g., a notification message indicating that the operating system account is logged in at a different location), a call message, a text message, etc. The notification message with the low urgency may include but not limited to: a notification message indicating updating a version of the operating system and/or the application, a notification message indicating push content of the application, etc.

The timeliness of the response of the model to the notification message i may indicate the processing speed or processing duration of the model for the notification message i. For example, a model with high timeliness may be configured to process the notification message i with high urgency within 30 seconds, and a model with low timeliness may be configured to process the notification message i with low urgency within 60 seconds.

It should be understood that the above only shows an example decision event of the server device 150 for the notification message. In actual application, the processing of the notification message by the server device 150 may involve more, fewer, or other events, and the embodiments of the present disclosure are not limited thereto.

In the above example, for the purpose of illustration, the time interval between the model starting to perform the decision event and the server device 150 starting to summarize the notification messages is denoted as t4, the time interval between the server device 150 starting to summarize the notification messages and the server device 150 sending the summary message is denoted as t5, and the time interval between the server device 150 sending the summary message and the summary message arriving at the application 130 of the client device 120 is denoted as t6. It may be understood that the summarization duration T2=t4+t5+t6.

It may be understood that because the model of the server device 150 may randomly use a certain summarization policy to summarize the notification message, in order to ensure that the client device 120 receives the summary message sent by the server device 150 in a timely manner, the duration for which the application 130 needs to remain in the active state (denoted as T) is at least the maximum value of the processing durations corresponding to the plurality of summarization policies (for example, the larger value of T1 and T2).

It should be understood that the above only shows example summarization policies for the notification messages in the client device 120. In actual application, the model may use any appropriate summarization policy to summarize the notification message, and the embodiments of the present disclosure are not limited thereto.

Continuing to refer to FIG. 2, after determining the duration for which the application 130 in the client device 120 is required to remain in the active state at least, the server device 150 may generate the duration information based on the determined duration. The server device 150 transmits (220) the duration information to the client device 120 via the communication link between the client device 120 and the server device 150. The client device 120 may receive (230) notification messages for the operating system, the application, etc. The client device 120 transmits (240) the received notification message to the server device 150 via the communication link. After the notification message is transmitted, because the application 130 of the client device 120 may be required to receive the summary message for the notification message from the server device 150, the client device 120 controls (250) the application 130 to remain in the active state at least for the duration indicated by the previously received duration information.

It may be understood that because the server device 150 may need to summarize messages after receiving a plurality of notification messages, the client device 120 may iteratively perform steps 230 to 250 indicated by the dotted box in FIG. 2 multiple times before receiving the summary message transmitted by the server device 150. Since the client device 120 is not aware of the summarization policy of the server device 150, it is impossible to determine after which notification message is reported that the summary message may be received from the server device 150. Therefore, every time after transmitting the notification message to the server device 150, the client device 120 always notifies the application 130 to remain in the active state for a period of time that is greater than or equal to the duration indicated by the server device 150.

In some embodiments, when the application 130 is in the foreground running state, the application may always remain in the active state, and the communication link may also be maintained without being disconnected. In some embodiments, if the application 130 is in the background running state, for example, the application is switched to the background by the user or the client device 120 is in the screen-locked state, the application 130 may be switched to the background state. If no action is taken actively, the application 130 will soon enter the suspended state, causing the communication link to be disconnected or set to the sleep state. Usually, the time for the application to switch from the background state to the suspended state may be less than the time for the server device 150 to generate the summary message after receiving the last notification message. Therefore, it is expected to control the client device 120 to remain in the active state, thereby maintaining the communication link to receive the summary message timely. Therefore, if the application 130 is in the background running state, to ensure that the application 130 may be in the active state for the required duration after each notification message is uploaded, the client device 120 may control the application 130 to remain in the active state through certain control measures. In some embodiments, different types of operating systems differ in many aspects such as system architecture and application ecosystem, resulting in that the management process of the client device 120 configured with different types of operating systems for the application 130 may be different.

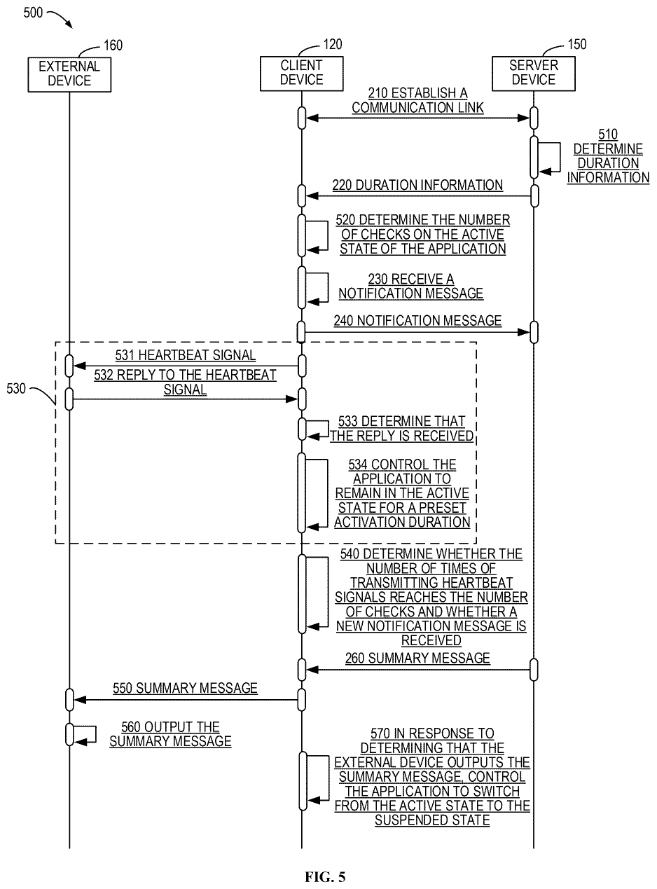

As an example, as shown in FIG. 5, after the client device 120 configured with the first type of operating system establishing (210) the communication link with the server device 150, the server device 150 may transmit (220) the duration information determined (510) by the server device 150 to the client device 120. Next, the client device 120 may determine (520) the number of checks on the active state of the application 130 (e.g., the background state 350 shown in FIG. 3) based on the duration indicated by the duration information and a predetermined time interval. It may be understood that the client device 120 configured with the first type of operating system may check the state of the application 130 based on heartbeat signal-based communication between the application 130 and the external device 160. The predetermined time interval may be a pre-configured event interval indicating two adjacent heartbeat signals transmitted by the application 130 to the external device 160.

The number of checks on the active state of the application 130 may be rounded up after dividing the duration indicated by the duration information by the predetermined time interval. As an example, if the duration indicated by the duration information is 30 seconds and the predetermined time interval is 5 seconds, the number of checks is determined as 6. As another example, if the duration indicated by the duration information is 27 seconds and the predetermined time interval is 5 seconds, the number of checks is also determined as 6. It should be understood that only example duration indicated by the duration information and example predetermined time interval are given here. In actual application, the duration indicated by the duration information may be determined based on the summarization policy for the notification message used by the server device 150, and the embodiments of the present disclosure are not limited thereto. The predetermined time interval may be determined based on the power consumption caused by the application 130 for remaining in the active state. As long as the predetermined time interval may reduce the power consumption of the application 130, the embodiments of the present disclosure are not limited thereto.

Continuing to refer to FIG. 5, after the client device 120 configured with the first type of operating system receiving (230) the notification message and transmitting (240) the notification message to the server device 150, the application 130 may first transmit (531) the heartbeat signal to the external device 160 to request to determine whether the client device 120 keeps a connection with the external device 160. The external device 160 may transmit (532) a determined reply to the heartbeat signal to the application 130. After the application 130 determines (533) that the reply from the external device 160 is received, or after the application 130 determines that the client device 120 keeps the connection with the external device 160, the client device 120 may control the application 130 to remain in the active state for a preset activation duration.

It may be understood that the preset activation duration is usually determined based on the configuration of the operating system of the client device 120. To keep the application 130 continuously in the active state for the duration indicated by the duration information, the predetermined time interval may be determined as the minimum value of the preset activation duration, or a value less than the minimum value of the preset activation duration. For example, if the preset activation duration is 7 seconds to 10 seconds, the predetermined time interval may be determined as 7 seconds or a value less than 7 seconds.

Continuing to refer to FIG. 5, after controlling the application 130 to remain in the active state for the preset activation duration corresponding to transmitting of a certain heartbeat signal, the client device 120 may determine (540) whether a number of times of transmitting heartbeat signals for a certain notification message reaches the number of checks and whether a new notification message is received. If it is determined that the number of times of transmitting heartbeat signals for the notification message does not reach the number of checks and no new notification message is received, the application 130 may transmit a next heartbeat signal to the external device 160 and accumulate the number of times of transmitting heartbeat signals. If it is determined that a new notification message is received when the number of times of transmitting heartbeat signals for the notification message does not reach or just reaches the number of checks, the application 130 resets the accumulated number of times of transmitting heartbeat signals to zero and restart steps 531 to 534 indicated by the dotted line 530. If it is determined that no new notification message is received when the number of times of transmitting heartbeat signals for the notification message reaches the number of checks, in order to reduce the power consumption of the application 130, the client device 120 may control the application 130 to be in the suspended state, so that the communication link between the client device 120 and the server device 150 is in the sleep state.

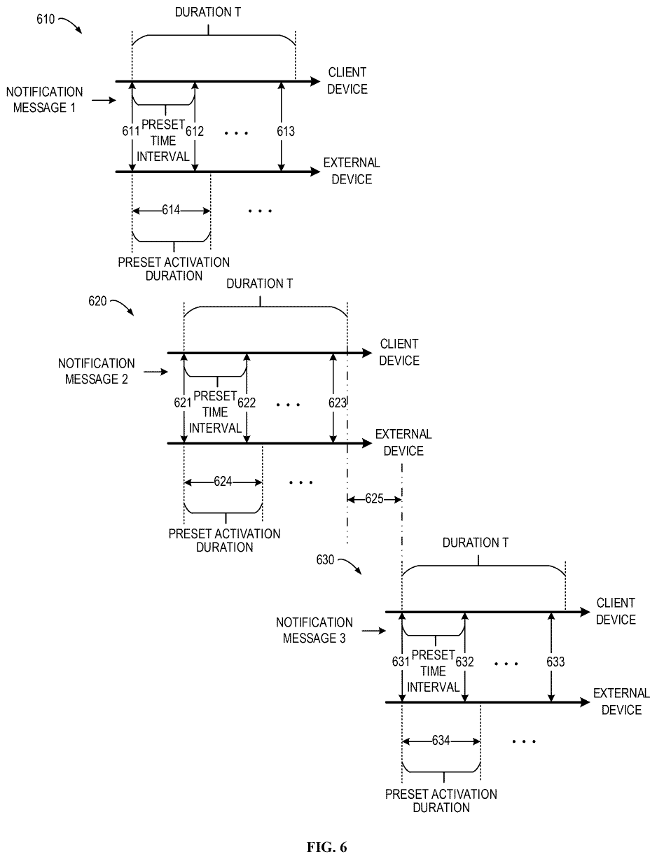

Referring to the example process of message communication shown in FIG. 6, an interaction process 610 between the client device 120 and the external device 160 for the notification message 1 includes: after the client device 120 receives the notification message 1 and transmits the notification message 1 to the server device 150, the application 130 may transmit the heartbeat signal to the external device 160 for multiple times at a predetermined time interval and receive replies to the heartbeat signals accordingly. For example, the application 130 transmits (611) a heartbeat signal to the external device 160 for the first time and receives a reply to the heartbeat signal accordingly, the application 130 transmits (612) a heartbeat signal to the external device 160 for the second time and receives a reply to the heartbeat signal accordingly, . . . , and the application 130 transmits (613) a heartbeat signal to the external device 160 for the Nth time and receives the reply to the heartbeat signal accordingly. After each time of receiving the reply to the heartbeat signal, the client device 120 may control (614) the application 130 to be at least in the active state for a preset activation duration, so as to ensure that the application 130 remains in the active state during the period when the cumulative duration of transmitting the heartbeat signals for the notification message 1 multiple times reaches the duration T indicated by the duration information.

Continuing to refer to an interaction process 620 between the client device 120 and the external device 160 for the notification message 2 shown in FIG. 6. When the time interval between the notification message 1 and the notification message 2 arriving at the client device 120 is short, the application 130 of the client device 120 may receive the notification message 2 before the number of times of transmitting the heartbeat signal for the notification message 1 reaches the number of checks. At this time, the application 130 resets the cumulative number of the heartbeat signals for the notification message 1 to zero, and iteratively performs the plurality of steps 531 to 534 indicated by the dotted line 530 shown in FIG. 5 to check the active state of the application 130. The interaction process 610 may specifically include: after the client device 120 receives the notification message 2 and transmits the notification message 2 to the server device 150, the application 130 may transmit the heartbeat signal to the external device 160 multiple times at a predetermined time interval and receive the reply to the heartbeat signal accordingly. For example, the application 130 transmits (621) a heartbeat signal to the external device 160 for the first time and receives a reply to the heartbeat signal accordingly, the application 130 transmits (622) a heartbeat signal to the external device 160 for the second time and receives a reply to the heartbeat signal accordingly, . . . , and the application 130 transmits (623) a heartbeat signal to the external device 160 for the Nth time and receives a reply to the heartbeat signal accordingly. After each time of receiving the reply to the heartbeat signal, the client device 120 may control (624) the application 130 to be at least in the active state for a preset activation duration, so as to ensure that the application 130 remains in the active state during the period when the cumulative duration of transmitting the heartbeat signals for the notification message 2 multiple times reaches the duration T indicated by the duration information.

Continuing to refer to an interaction process 630 between the client device 120 and the external device 160 for the notification message 3 shown in FIG. 6. When the time interval between the notification message 2 and the notification message 3 arriving at the client device 120 is long and exceeds the duration T, the application 130 of the client device 120 may not receive the notification message 3 when the number of times of transmitting the heartbeat signal for the notification message 1 reaches the number of checks. At this time, to reduce the power consumption of the application 130, the client device 120 controls the application 130 to switch from the active state to the suspended state and controls (625) the application 130 to remain in the suspended state for a period of time until the notification message 3 is received.

After receiving the notification message 3, the client device 120 may perform the interaction process 630 with the external device 160. The interaction process 630 may specifically include: after the client device 120 receives the notification message 3 and transmits the notification message 3 to the server device 150, the application 130 may transmit the heartbeat signal to the external device 160 multiple times at a predetermined time interval and receive the reply to the heartbeat signal accordingly. For example, the application 130 transmits (631) a heartbeat signal to the external device 160 for the first time and receives a reply to the heartbeat signal accordingly, the application 130 transmits (632) a heartbeat signal to the external device 160 for the second time and receives a reply to the heartbeat signal accordingly, . . . , and the application 130 transmits (633) the heartbeat signal to the external device 160 for the Nth time and receives the reply to the heartbeat signal accordingly. After each time of receiving the reply to the heartbeat signal, the client device 120 may control (634) the application 130 to be at least in the active state for the preset activation duration, so as to ensure that the application 130 remains in the active state during the period when the cumulative duration of transmitting the heartbeat signals for the notification message 3 multiple times reaches the duration T indicated by the duration information.

Continuing to refer to FIG. 5, during the period when the client device 120 controls the application 130 to remain in the active state, the application 130 of the client device 120 receives (260) the summary message from the server device 150 via the communication link. The application 130 may transmit (550) the summary message to the external device 160. Then, the external device 160 outputs (560) the summary message to present to the user 110. Next, the client device 120 configured with the first type of operating system may control (570) the application 130 to switch from the active state to the suspended state in response to determining that the external device 160 outputs the summary message, to further reduce the power consumption of the application 130.

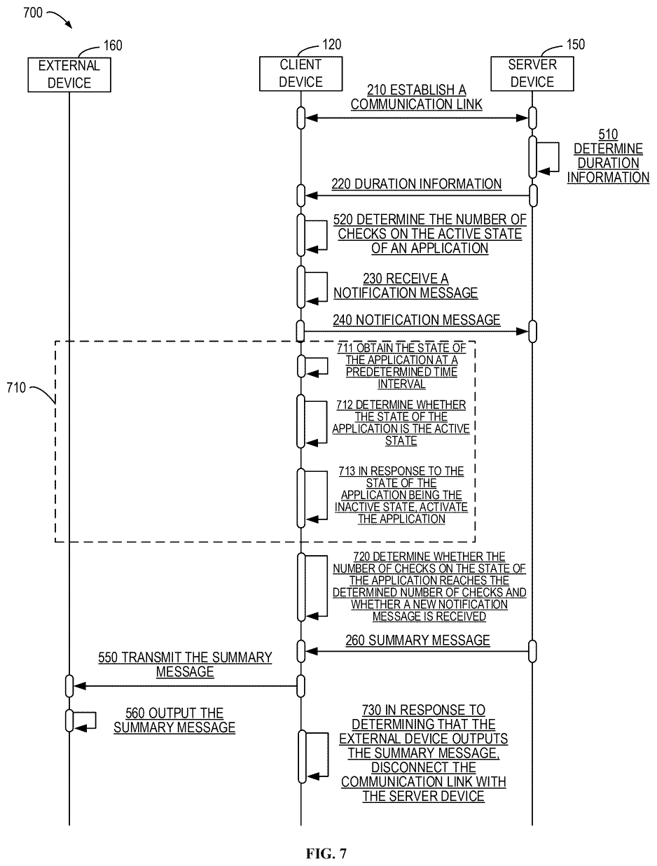

As another example, as shown in FIG. 7, after the client device 120 configured with the second type of operating system establishes (210) the communication link with the server device 150, the server device 150 may transmit (220) the duration information determined (510) by the server device 150 to the client device 120. Next, the client device 120 may determine (520) the number of checks on the active state of the application 130 based on the duration indicated by the duration information and the predetermined time interval. It may be understood that the client device 120 configured with the second type of operating system may check the state of the application 130 at the predetermined time interval. The predetermined time interval may be a pre-configured time interval indicating that the operating system obtains and checks the state of the application 130 twice in a row.

The number of checks on the active state of the application 130 may be rounded up after dividing the duration indicated by the duration information by the predetermined time interval. As an example, if the duration indicated by the duration information is 20 seconds and the predetermined time interval is 5 seconds, the number of checks is 4. As another example, if the duration indicated by the duration information is 17 seconds and the predetermined time interval is 5 seconds, the number of checks is also 4. It should be understood that only example duration indicated by the duration information and example predetermined time interval are given here. In actual application, the duration indicated by the duration information may be determined based on the summarization policy for the notification message used by the server device 150, and the embodiments of the present disclosure are not limited thereto. The predetermined time interval may be determined based on the power consumption caused by the application 130 for remaining in the active state. As long as the predetermined time interval may reduce the power consumption of the application 130, the embodiments of the present disclosure are not limited thereto.

Continuing to refer to FIG. 7, after the client device 120 configured with the second type of operating system receives (230) the notification message and transmits (240) the notification message to the server device 150, the operating system of the client device 120 may first obtain (711) the current state of the application 130 at the predetermined time interval. The operating system determines (712) whether the current state of the application 130 is the active state. If the operating system determines (712) that the current state of the application 130 is the inactive state, the operating system activates (713) the application 130. If the operating system determines (712) that the current state of the application 130 is the active state, it may further determine (720) whether the cumulative number of checks on the state of the application 130 reaches the number of checks and whether a new notification message is received.

If it is determined that the cumulative number of checks on the state of the application 130 for a certain notification message does not reach the number of checks and no new notification message is received, the operating system of the client device 120 may obtain and check the state of the application 130 again after waiting for the predetermined time interval, and accumulate the number of checks on the state of the application 130. If it is determined that a new notification message is received when the cumulative number of checks on the state of the application 130 for the notification message does not reach or just reaches the number of checks, the operating system may reset the cumulative number of checks on the state of the application 130 to zero and restart steps 711 to 713 as indicated by the dotted line 710. If it is determined that no new notification message is received when the cumulative number of checks on the state of the application 130 for the notification message reaches the number of checks, in order to reduce the power consumption of the application 130, the client device 120 may control the application 130 to be in the suspended state, so that the communication link between the client device 120 and the server device 150 is in the sleep state.

Continuing to refer to FIG. 7, during the period when the client device 120 controls the application 130 to remain in the active state, the application 130 of the client device 120 receives (260) the summary message from the server device 150 via the communication link. The application 130 may transmit (550) the summary message to the external device 160. Then, the external device 160 outputs (560) the summary message to present to the user 110. Next, the client device 120 configured with the second type of operating system may control (730) to disconnect the communication link between the client device 120 and the server device 150 in response to determining that the external device 160 outputs the summary message, to reduce the power consumption of the operating system and prolong the service life of the client device 120.

It should be understood that the above only shows examples in which the two types of operating systems control the application in the client device to remain in the active state for a period of time. In actual application, after the application in the client device is switched to running in the background, any other suitable manner may be used to control the application to remain in the active state, and the embodiments of the present disclosure are not limited thereto.

In this way, the embodiments of the present disclosure may control the duration for which the application in the client device remains in the active state to reach at least the summarization duration determined based on the summarization policy for the notification message (for example, the above-mentioned summarization policy) by the server device, after the client device transmits the received notification message to the server device. In this way, the client device may receive the summary message from the server in a timely manner and present the summary message to the user through the external device in a timely manner, improving the user experience. In addition, the embodiments of the present disclosure may further control the application to switch from the active state to the suspended state in time when the time interval between the client device receiving two adjacent notification messages is greater than the summarization duration determined by the server device, to reduce the power consumption of the application and prolong the service life of the client device.

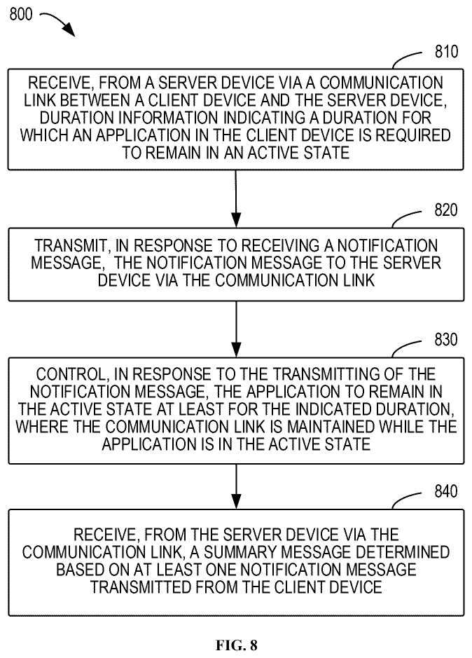

FIG. 8 illustrates a flowchart of an example process 800 of message communication according to some embodiments of the present disclosure. The process 800 may be implemented at the client device 120. The process 800 is described below with reference to FIG. 1.

As shown in FIG. 8, at block 810, the client device 120 receives from a server device via a communication link between the client device and the server device, duration information indicating a duration for which an application in the client device is required to remain in an active state.

At block 820, the client device 120 transmits, in response to receiving a notification message, the notification message to the server device via the communication link.

At block 830, the client device 120 controls, in response to the transmitting of the notification message, the application to remain in the active state at least for the indicated duration, wherein the communication link is maintained while the application is in the active state.

At block 840, the client device 120 receives, from the server device via the communication link, a summary message determined based on at least one notification message transmitted from the client device.

In some embodiments, the duration indicated by the duration information is determined based on a summarization policy at the server device 150 for notification messages reported by the client device 120.

In some embodiments, the client device 120 may determine a number of checks on the active state of the application 130 based on the indicated duration and a predetermined time interval; and control the application 130 to remain in the active state at least for the indicated duration by performing checks on a state of the application 130 for the number of checks.

In some embodiments, the client device 120 is connected to an external device, and controlling the application 130 to remain in the active state at least for the indicated duration by performing checks on the state of the application 130 for the number of checks includes: controlling the application 130 to iteratively perform the following operations until a number of times of transmitting heartbeat signals to the external device 160 reaches the number of checks or a next notification message is received: transmitting a heartbeat signal to the external device 160 at the predetermined time interval; receiving a reply to the heartbeat signal from the external device 160; and controlling, in response to receiving the reply, the application 130 to remain in the active state for a preset activation duration.

Based on the above embodiments, the present disclosure may ensure that the client device 120 receives the summary message from the server device 150 in a timely manner.

In some embodiments, the client device 120 controls, in response to not receiving the reply to the heartbeat signal, the connection between the client device 120 and the external device 160 to be restored; and transmits a next heartbeat signal to the external device 160 after the connection is restored. In this way, the embodiments of the present disclosure may ensure that the duration of checking the state of the application 130 by the client device 120 configured with the first type of operating system is shortened, and further ensure the timeliness of the client device 120 receiving the summary message.

In some embodiments, controlling the application 130 to remain in the active state at least for the indicated duration by performing checks on the state of the application 130 for the number of checks includes: performing the following operations until a number of checks on the state of the application 130 by the client device 120 reaches the number of checks or the next notification message is received: obtaining the state of the application 130 at the predetermined time interval; and activating the application 130 in response to determining that the state of the application 130 is the inactive state. In this way, the embodiments of the present disclosure may ensure that the duration of checking the state of the application 130 by the client device 120 configured with the second type of operating system is shortened, and further ensure the timeliness of the client device 120 receiving the summary message.

In some embodiments, the client device 120 controls the application 130 to switch from the active state to the suspended state in response to receiving no new notification message after the application 130 remains in the active state for a first duration, where the communication link between the client device 120 and the server device 150 is in the sleep state when the application 130 is in the suspended state. In this way, the embodiments of the present disclosure may achieve such an effect that when the time interval between the client device receiving two adjacent notification messages is greater than the summarization duration determined by the server device, the application is controlled to switch from the active state to the suspended state in time, to reduce the power consumption of the application and prolong the service life of the client device.

In some embodiments, the client device 120 is connected to an external device 160, and the client device 120 transmits the summary message to the external device 160 to output the summary message via the external device 160. In this way, the embodiments of the present disclosure may ensure that the summary message for the notification message is presented to the user in a timely manner, improving the user experience.

In some embodiments, the client device 120 controls in response to an operating system of the client device 120 being a first type of operating system and in response to the external device 160 outputting the summary message the application 130 to switch from the active state to the suspended state to cause the communication link to be in the sleep state; and disconnects the communication link in response to the operating system of the client device 120 being a second type of operating system and in response to the external device 160 outputting the summary message. In this way, the embodiments of the present disclosure may ensure that when the application in the client device does not need to perform a task, the state of the application is switched to the suspended state in time or the communication link between the application and the server device is disconnected in time, to further reduce the power consumption of the application and prolong the service life of the client device.

The embodiments of the present disclosure further provide a corresponding apparatus for implementing the above method or process. FIG. 9 illustrates a schematic structural block diagram of an example apparatus 900 for message communication according to some embodiments of the present disclosure. The apparatus 900 may be implemented as or included in the client device 120. Each module/component in the apparatus 900 may be implemented by hardware, software, firmware, or any combination thereof.

As shown in FIG. 9, the apparatus 900 includes: an information receiving module 910 configured to receive, from a server device via a communication link between a client device and the server device, duration information indicating a duration for which an application in the client device is required to remain in an active state; a message transmitting module 920 configured to transmit, in response to receiving a notification message, the notification message to the server device via the communication link; a state control module 930 configured to control, in response to the transmitting of the notification message, the application to remain in the active state at least for the indicated duration, wherein the communication link is maintained while the application is in the active state; and a message summary module 940 configured to receive, from the server device via the communication link, a summary message determined based on at least one notification message transmitted from the client device.

In some embodiments, the duration indicated by the duration information is determined based on a summarization policy at the server device 150 for notification messages reported by the client device 120.

In some embodiments, the state control module 930 may be further configured such that the client device 120 may determine a number of checks on the active state of the application 130 based on the indicated duration and a predetermined time interval; and the client device 120 may control the application 130 to remain in the active state at least for the indicated duration by performing checks on a state of the application 130 for the number of checks.

In some embodiments, the client device 120 is connected to an external device, and the state control module 930 may be further configured such that the client device 120 controls the application 130 to iteratively perform the following operations until a number of times of transmitting heartbeat signals to the external device 160 reaches the number of checks or a next notification message is received: transmitting a heartbeat signal to the external device 160 at the predetermined time interval; receiving a reply to the heartbeat signal from the external device 160; and controlling, in response to receiving the reply, the application 130 to remain in the active state for a preset activation duration.

In some embodiments, the state control module 930 may be further configured such that the client device 120 controls, in response to not receiving the reply to the heartbeat signal, the connection between the client device 120 and the external device 160 to be restored; and transmits a next heartbeat signal to the external device 160 after the connection is restored.

In some embodiments, the state control module 930 may be further configured such that the client device 120 performs the following operations until a number of checks on the state of the application 130 by the client device 120 reaches the number of checks or the next notification message is received: obtaining the state of the application 130 at the predetermined time interval; and activating the application 130 in response to determining that the state of the application 130 is an inactive state.

In some embodiments, the apparatus 900 further includes: a first state switching module configured such that the client device 120 controls the application 130 to switch from the active state to a suspended state in response to receiving no new notification message after the application 130 remains in the active state for a first duration, where the communication link between the client device 120 and the server device 150 is in a sleep state when the application 130 is in the suspended state.

In some embodiments, the client device 120 is connected to the external device 160, and the apparatus 900 further includes: a message output module configured such that the client device 120 transmits the summary message to the external device 160 to output the summary message via the external device 160.

In some embodiments, the apparatus 900 further includes: a second state switching module configured such that the client device 120 controls, in response to an operating system of the client device 120 being a first type of operating system and in response to the external device 160 outputting the summary message, the application 130 to switch from the active state to the suspended state to cause the communication link to be in the sleep state; and disconnects the communication link in response to the operating system of the client device 120 being a second type of operating system and in response to the external device 160 outputting the summary message.

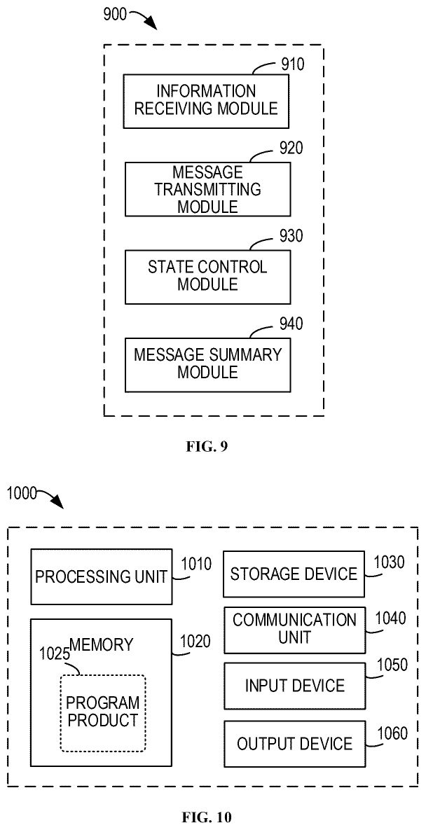

FIG. 10 illustrates a block diagram of an electronic device capable of implementing a plurality of embodiments of the present disclosure. As shown in FIG. 10, the electronic device 1000 is in the form of a general electronic device. Components of the electronic device 1000 may include, but not limited to, at least one processor or processing unit 1010, a memory 1020, a storage device 1030, one or more communication units 1040, one or more input devices 1050, and one or more output devices 1060. The processor 1010 may be an actual or virtual processor and may perform various processing according to a program stored in the memory 1020. In a multi-processor system, a plurality of processors execute computer-executable instructions in parallel to improve the parallel processing capability of the electronic device 1000.

The electronic device 1000 typically includes a plurality of computer storage medium. Such medium may be any available medium that is accessible to the electronic device 1000, including but not limited to volatile and non-volatile medium, removable and non-removable medium. The memory 1020 may be volatile memory (for example, a register, cache, a random access memory (RAM)), a non-volatile memory (for example, a read-only memory (ROM), an electrically erasable programmable read-only memory (EEPROM), a flash memory), or any combination thereof. The storage device 1030 may be any removable or non-removable medium, and may include machine-readable medium, such as a flash drive, a disk, or any other medium, which may be used for storing information and/or data and may be accessed within the electronic device 1000.

The electronic device 1000 may further include additional removable/non-removable, volatile/non-volatile storage medium. Although not shown in FIG. 10, a disk drive for reading from or writing to a removable, non-volatile disk (such as a “floppy disk”), and an optical disk drive for reading from or writing to a removable, non-volatile optical disk may be provided. In these cases, each drive may be connected to a bus (not shown) by one or more data medium interfaces. The memory 1020 may include a computer program product 1025, which has one or more program modules configured to perform various methods or actions of the various embodiments of the present disclosure.

The communication unit 1040 implements communication with other electronic devices through the communication medium. Additionally, the functions of the components of the electronic device 1000 may be implemented by a single computing cluster or a plurality of computing machines, which may communicate through communication links. Therefore, the electronic device 1000 may use a logical connection with one or more other servers, network personal computers (PCs) or another network node to operate in a networked environment.

The input device 1050 may be one or more input devices, such as a mouse, a keyboard, a tracking ball, etc. The output device 1060 may be one or more output devices, such as a display, a speaker, a printer, etc. The electronic device 1000 may also communicate with one or more external devices (not shown) such as a storage device, a display device, etc., with one or more devices that enable the user to interact with the electronic device 1000, or with any device (e.g., a network card, a modem, etc.) that enables the electronic device 1000 to communicate with one or more other electronic devices, as needed, through the communication unit 1040. Such communication may be performed via input/output (I/O) interfaces (not shown).

According to an example implementation of the present disclosure, a computer-readable storage medium is provided, which has computer-executable instructions stored thereon, where the computer-executable instructions are executed by a processor to implement the method described above. According to an example implementation of the present disclosure, there is also provided a computer program product, which is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to a processor of a general-purpose computer, a special-purpose computer, or other programmable data processing apparatus to produce a machine, such that these instructions, when executed by the processor of the computer or other programmable data processing apparatus, produce an apparatus for implementing a function/action specified in one or more blocks of the flowcharts and/or block diagrams. These computer-readable program instructions may also be stored in a computer-readable storage medium, and these instructions cause the computer, the programmable data processing apparatus, and/or other devices to work in a specific manner, and thus, the computer-readable medium storing the instructions includes a manufactured product, which includes instructions for implementing various aspects of the function/action specified in one or more blocks of the flowcharts and/or block diagrams.

The computer-readable program instructions may be loaded onto a computer, another programmable data processing apparatus, or other devices, so that a series of operation steps are executed on the computer, the other programmable data processing apparatus, or the other devices to produce a computer-implemented process, so that the instructions executed on the computer, the other programmable data processing apparatus, or the other devices implement the function/action specified in one or more blocks of the flowcharts and/or block diagrams.

The flowcharts and block diagrams in the drawings show the architecture, function, and operation of possible implementations of the system, method, and computer program product according to multiple implementations of the present disclosure. In this regard, each block in the flowchart or block diagram may represent a module, program segment, or part of instruction, and the module, program segment, or part of instruction contains one or more executable instructions for implementing the specified logical function. In some alternative implementations, the functions marked in the blocks may also occur in a different order from that marked in the drawings. For example, two consecutive blocks may actually be executed substantially in parallel, or they may sometimes be executed in the reverse order, depending on the functions involved. It should also be noted that each block in the block diagram and/or the flowchart, and the combination of the blocks in the block diagram and/or the flowchart may be implemented by a special-purpose hardware-based system that executes the specified functions or actions, or by a combination of special-purpose hardware and computer instructions.

The implementations of the present disclosure have been described above, and the above descriptions are examples, not exhaustive, and is not limited to the disclosed implementations. Without departing from the scope and spirit of the described implementations, many modifications and changes will be apparent to those of ordinary skill in the art. The selection of terms used herein is intended to best explain the principles, practical applications, or improvements to the technology in the market of each implementation, or to enable other ordinary skilled persons in the art to understand the various implementations disclosed herein.

1. A method of message communication, implemented at a client device, comprising:
receiving, from a server device via a communication link between the client device and the server device, duration information indicating a duration for which an application in the client device is required to remain in an active state;
transmitting, in response to receiving a notification message, the notification message to the server device via the communication link;
controlling, in response to the transmitting of the notification message, the application to remain in the active state at least for the indicated duration, wherein the communication link is maintained while the application is in the active state; and
receiving, from the server device via the communication link, a summary message determined based on at least one notification message transmitted from the client device.

2. The method of claim 1, wherein the indicated duration is determined based on a summarization policy at the server device for notification messages reported by the client device.

3. The method of claim 1, wherein controlling the application to remain in the active state at least for the indicated duration comprises:
determining a number of checks on the active state of the application based on the indicated duration and a predetermined time interval; and
controlling the application to remain in the active state at least for the indicated duration by performing checks on a state of the application for the number of checks.

4. The method of claim 3, wherein the client device is connected to an external device, and wherein controlling the application to remain in the active state at least for the indicated duration by performing checks on the state of the application for the number of checks comprises:
controlling the application to iteratively perform the following operations until a number of times of transmitting heartbeat signals to the external device reaches the number of checks or a next notification message is received:
transmitting a heartbeat signal to the external device at the predetermined time interval;
receiving a reply to the heartbeat signal from the external device; and
controlling, in response to receiving the reply, the application to remain in the active state for a preset activation duration.

5. The method of claim 4, further comprising:
controlling, in response to not receiving the reply to the heartbeat signal, the connection between the client device and the external device to be restored; and
transmitting a next heartbeat signal to the external device after the connection is restored.

6. The method of claim 3, wherein controlling the application to remain in the active state at least for the indicated duration by performing checks on the state of the application for the number of checks comprises:
performing the following operations until a number of checks performed on the state of the application by the client device reaches the number of checks or a next notification message is received:
obtaining the state of the application at the predetermined time interval; and
activating the application in response to determining that the state of the application is an inactive state.

7. The method of claim 1, further comprising:
controlling the application to switch from the active state to a suspended state in response to receiving no new notification message after the application remains in the active state for a first duration, and
wherein the communication link between the client device and the server device is in a sleep state when the application is in the suspended state.

8. The method of claim 1, wherein the client device is connected to an external device, and the method further comprises:
transmitting the summary message to the external device to output the summary message via the external device.

9. The method of claim 8, further comprising:
controlling, in response to an operating system of the client device being a first type of operating system and in response to the external device outputting the summary message, the application to switch from the active state to a suspended state to cause the communication link to be in a sleep state; and
disconnecting the communication link in response to the operating system of the client device being a second type of operating system and in response to the external device outputting the summary message.

10. An electronic device, comprising:
at least one processor; and
at least one memory coupled to the at least one processor and storing instructions executable by the at least one processor, the instructions, when executed by the at least one processor, causing the electronic device to perform operations comprising:
receiving, from a server device via a communication link between the client device and the server device, duration information indicating a duration for which an application in the client device is required to remain in an active state;
transmitting, in response to receiving a notification message, the notification message to the server device via the communication link;
controlling, in response to the transmitting of the notification message, the application to remain in the active state at least for the indicated duration, wherein the communication link is maintained while the application is in the active state; and
receiving, from the server device via the communication link, a summary message determined based on at least one notification message transmitted from the client device.

11. The electronic device of claim 10, wherein the indicated duration is determined based on a summarization policy at the server device for notification messages reported by the client device.

12. The electronic device of claim 10, wherein controlling the application to remain in the active state at least for the indicated duration comprises:
determining a number of checks on the active state of the application based on the indicated duration and a predetermined time interval; and
controlling the application to remain in the active state at least for the indicated duration by performing checks on a state of the application for the number of checks.

13. The electronic device of claim 12, wherein the client device is connected to an external device, and wherein controlling the application to remain in the active state at least for the indicated duration by performing checks on the state of the application for the number of checks comprises:
controlling the application to iteratively perform the following operations until a number of times of transmitting heartbeat signals to the external device reaches the number of checks or a next notification message is received:
transmitting a heartbeat signal to the external device at the predetermined time interval;
receiving a reply to the heartbeat signal from the external device; and
controlling, in response to receiving the reply, the application to remain in the active state for a preset activation duration.

14. The electronic device of claim 13, wherein the operations further comprise:
controlling, in response to not receiving the reply to the heartbeat signal, the connection between the client device and the external device to be restored; and
transmitting a next heartbeat signal to the external device after the connection is restored.

15. The electronic device of claim 12, wherein controlling the application to remain in the active state at least for the indicated duration by performing checks on the state of the application for the number of checks comprises:
performing the following operations until a number of checks performed on the state of the application by the client device reaches the number of checks or a next notification message is received:
obtaining the state of the application at the predetermined time interval; and
activating the application in response to determining that the state of the application is an inactive state.

16. The electronic device of claim 10, wherein the operations further comprise:
controlling the application to switch from the active state to a suspended state in response to receiving no new notification message after the application remains in the active state for a first duration, and
wherein the communication link between the client device and the server device is in a sleep state when the application is in the suspended state.

17. The electronic device of claim 10, wherein the client device is connected to an external device, and the operations further comprise:
transmitting the summary message to the external device to output the summary message via the external device.

18. The electronic device of claim 17, wherein the operations further comprise:
controlling, in response to an operating system of the client device being a first type of operating system and in response to the external device outputting the summary message, the application to switch from the active state to a suspended state to cause the communication link to be in a sleep state; and
disconnecting the communication link in response to the operating system of the client device being a second type of operating system and in response to the external device outputting the summary message.

19. A non-transitory computer-readable storage medium having computer-executable instructions stored thereon, the computer-executable instructions being executable by a processor to implement operations comprising:
receiving, from a server device via a communication link between the client device and the server device, duration information indicating a duration for which an application in the client device is required to remain in an active state;
transmitting, in response to receiving a notification message, the notification message to the server device via the communication link;
controlling, in response to the transmitting of the notification message, the application to remain in the active state at least for the indicated duration, wherein the communication link is maintained while the application is in the active state; and
receiving, from the server device via the communication link, a summary message determined based on at least one notification message transmitted from the client device.

20. The non-transitory computer-readable storage medium of claim 19, wherein the indicated duration is determined based on a summarization policy at the server device for notification messages reported by the client device.
